(19) United States
(12) Patent Application Publication
(10) Pub. No.: US 2013/0081450 A1
(43) Pub. Date: Apr. 4, 2013

(54) DEVICE FOR TESTING DROPLETS AND OPERATING METHOD THEREOF

(71) Applicants: Hee Ju Son, Suwon (KR); Sang Youl Jeon, Seoul (KR); Sang Jin Kim, Suwon (KR); Bo Sung Ku, Suwon (KR)

(72) Inventors: Hee Ju Son, Suwon (KR); Sang Youl Jeon, Seoul (KR); Sang Jin Kim, Suwon (KR); Bo Sung Ku, Suwon (KR)

(73) Assignee: SAMSUNG ELECTRO-MECHANICS CO., LTD.

(21) Appl. No.: 13/363,955

(22) Filed: Feb. 1, 2012

(30) Foreign Application Priority Data
Sep. 30, 2011 (KR) 10-2011-0099652

(51) Int. Cl. G01N 1/14

(52) U.S. Cl. 73/64.56

(57) ABSTRACT

There are provided a device for testing droplets and an operation method thereof. The device includes a receiving layer on which a sample is received; a plurality of pressure sensors disposed below the receiving layer, and generating changes in capacitance by the sample received on the receiving layer; and a control unit measuring changes in capacitance generated by the plurality of pressure sensors and determining whether the sample received on the receiving layer is defective. According to the present invention, a location and an amount of a sample received on a receiving layer are measured based on changes in capacitance generated by a plurality of respective pressure sensors disposed below the receiving layer, thereby precisely testing whether the sample ejected in droplet form is defective.

### CROSS-REFERENCE TO RELATED APPLICATIONS

This application claims the priority of Korean Patent Application No. 10-2011-0099652 filed on Sep. 30, 2011, in the Korean Intellectual Property Office, the disclosure of which is incorporated herein by reference.

### BACKGROUND OF THE INVENTION

1. Field of the Invention

The present invention relates to a device for testing droplets, including a plurality of pressure sensors provided below a receiving layer on which a sample is received, and determining whether the sample is defective from changes in capacitance generated by the plurality of pressure sensors, thereby precisely controlling a nozzle for ejecting a droplet sample, and an operating method thereof.

2. Description of the Related Art

In general, a minute ejection head for ejecting a predetermined amount of droplets from a nozzle is widely applied to printers as well as semiconductor processing and reagent testing devices, and the like. A minute ejection head includes a nozzle for ejecting a desired amount of droplets and a receiving layer on which the droplets ejected from the nozzle are received, which has an important function of allowing a desired amount of droplets to be precisely received in a desired location of the receiving layer. Thus, a conventional minute ejection head may test whether droplets are defective through a device for testing droplets, and control the droplets ejection of the nozzle according to a test result.

FIG. 1 schematically shows a conventional device for testing droplets. Referring to FIG. 1, a conventional device 100 for testing droplets includes a nozzle 110 for ejecting a sample 105 in droplet form, a sample receiving unit 120 on which the sample 105 is received, and a light source 130 and a light detecting unit 140 for measuring directionality of the sample 105.

The conventional device 100 for testing droplets shown in FIG. 1 measures directionality of the sample 105 by using the light source 130 and the light detecting unit 140 disposed in a path of the sample 105 dropped to the sample receiving unit 120 from the nozzle 110, thereby determining whether the sample 105 is defective. That is, the conventional device 100 for testing droplets initially designates a path through which the sample 105 passes to be normally received on the sample receiving unit 120, detects a defect in the sample 105 if the sample 105 is dropped away from the path at a distance exceeding a predetermined range, and adjusts a location of the nozzle 110 or the sample receiving unit 120 accordingly.

However, the conventional device 100 for testing droplets shown in FIG. 1 may only detect a defect in the sample 105 in a specific direction to which the sample 105 drops, according to locations of the light source 130 and the light detecting unit 140 (only in axial direction “z” of FIG. 1), and may not detect whether the sample 105 is defective, based on an amount thereof, other than the location and direction of the sample 105.

### SUMMARY OF THE INVENTION

An aspect of the present invention provides a device for testing droplets including a plurality of pressure sensors disposed below a receiving layer on which a sample is received, and determining whether the sample is defective from changes in capacitance generated by the plurality of pressure sensors, thereby precisely testing a defect in the sample according to a location and amount of the sample, and an operating method thereof.

According to an aspect of the present invention, there is provided a device for testing droplets, the device including: a receiving layer on which a sample is received; a plurality of pressure sensors disposed below the receiving layer, and generating changes in capacitance by the sample received on the receiving layer; and a control unit measuring changes in capacitance generated by the plurality of pressure sensors and determining whether the sample received on the receiving layer is defective.

The plurality of pressure sensors may be disposed below the receiving layer to have a predetermined pattern.

The control unit may determine at least one of an amount and a location of the sample received on the receiving layer based on the changes in capacitance.

The control unit may adjust a nozzle for ejecting the sample when the control unit determines that at least one of the amount and the location of the sample received on the receiving layer is beyond a previously set threshold range.

The control unit may control the nozzle for ejecting the sample such that the nozzle is cleaned, when the control unit determines that the amount of the sample received on the receiving layer is beyond the previously set threshold range.

The control unit may adjust a location of the nozzle for ejecting the sample when the control unit determines that the location of the sample received on the receiving layer is beyond the previously set threshold range.

The control unit may reset the previously set threshold range when a rate of the sample determined to be defective is greater than a specific numerical value, the sample being received on the receiving layer.

According to another aspect of the present invention, there is provided a method of operating a device for testing droplets, the method including: receiving a sample ejected from a nozzle; measuring changes in capacitance generated by a plurality of pressure sensors by the sample; determining whether the sample is defective based on the changes in capacitance; and controlling the nozzle according to whether the sample is defective.

The measuring of changes in capacitance may include: measuring changes in capacitance generated by the plurality of pressure sensors disposed to have a predetermined pattern.

The determining of whether the sample is defective, may include: determining that the sample is defective when at least one of an amount and a location of the sample detected from the changes in capacitance is beyond a previously set threshold range.

The controlling of the nozzle may include cleaning the nozzle when the amount of the sample is beyond the previously set threshold range.

The controlling of the nozzle may include adjusting a location of the nozzle when the location of the sample is beyond the previously set threshold range.

The method may further include resetting the previously set threshold range when a rate of the sample determined to be defective is greater than a specific numerical value, the sample being received on the receiving layer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 schematically shows a conventional device for testing droplets;

FIG. 2 is a block diagram of a device for testing droplets according to an embodiment of the present invention;

FIGS. 3A, 3B, and 4 are diagrams for explaining an operation of a device for testing droplets according to an embodiment of the present invention; and

FIG. 5 is a flowchart of a method of operating a device for testing droplets according to an embodiment of the present invention.

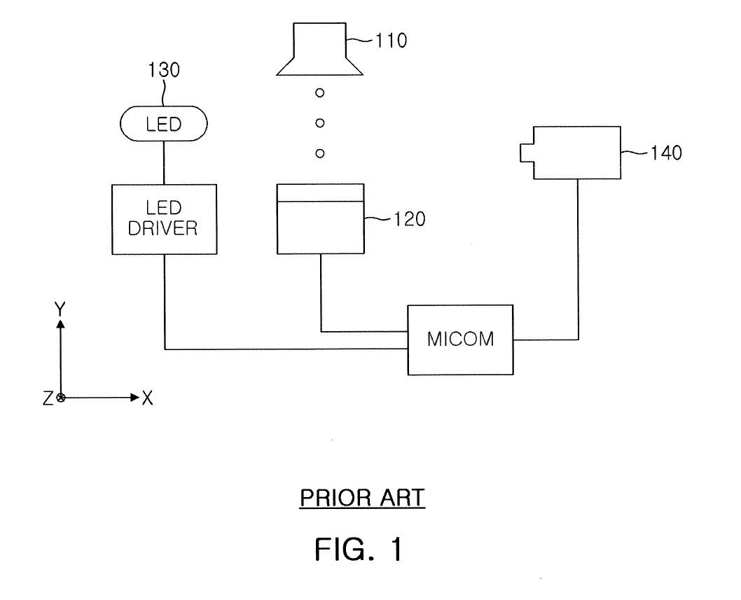

### DETAILED DESCRIPTION OF THE INVENTION

Embodiments of the present invention will now be described in detail with reference to the accompanying drawings. The present invention will now be described more fully with reference to the accompanying drawings, in which embodiments of the invention are shown. In the following detailed description, only certain exemplary embodiments of the present invention have been shown and described, simply by way of illustration. As those skilled in the art would realize, the described embodiments maybe modified in various different ways, all without departing from the spirit or scope of the present invention. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. Like reference numerals denote same or like elements throughout.

Hereinafter, the present invention will be described in detail by explaining preferred embodiments of the invention with reference to the attached drawings so that the present invention would have been obvious to one of ordinary skill in the art.

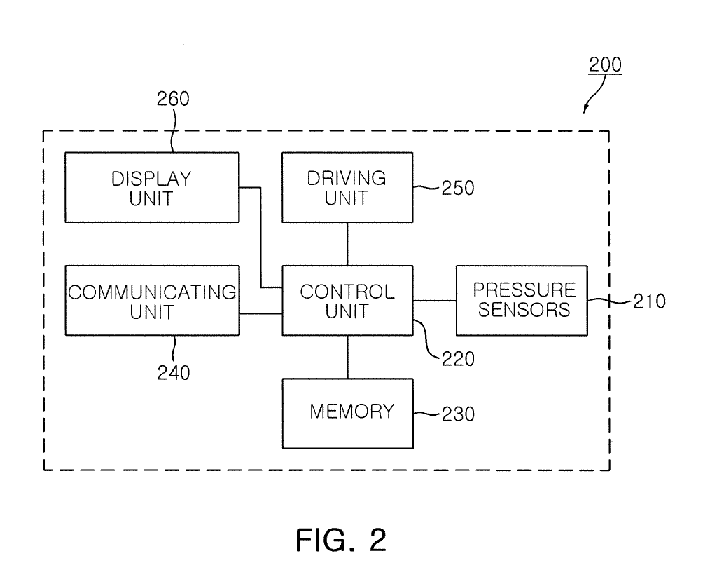

FIG. 2 is a block diagram of a device 200 for testing droplets according to an embodiment of the present invention.

Referring to FIG. 2, the device 200 for testing droplets according to the present embodiment includes a plurality of pressure sensors 210, a control unit 220, a memory 230, a communicating unit 240, a driving unit 250, and a display unit 260. The elements shown in FIG. 2 are merely an embodiment of the present invention, and other elements may be further included or some of the elements shown in FIG. 2 may be replaced with other elements.

The pressure sensors 210 are sensors for generating predetermined electrical signals according to pressures applied from the outside, and may be disposed below a receiving layer on which a sample ejected from an external nozzle is received. The “below a receiving layer” refers to “disposed to be opposed to a surface on which the sample is received, which will be described below.

As an example, the device 200 for testing droplets may include the plurality of pressure sensors 210. The plurality of pressure sensors 210 are disposed in a predetermined pattern below the receiving layer, so that the device 200 for testing droplets may determine whether an amount of the sample and a location thereof are defective, and precisely test a minute error in sample ejection.

The pressure sensors 210 may include two conductive substrates parallel to each other and a dielectric layer having elasticity disposed therebetween. At least one of the two conductive substrates is electrically connected to the control unit 220. Changes in capacitance generated due to a change in a thickness of the dielectric layer according to pressure applied to the plurality of pressure sensors 210 by the sample received on the receiving layer may be measured by the control unit 220. The control unit 220 may include a charge charging/discharging circuit for measuring the changes in capacitance generated due to the change in the thickness of the dielectric layer, a charge pump, an analog-to-digital (ADC) circuit, or the like.

The control unit 220 is an apparatus for controlling a general operation of the device 200 for testing droplets, and may measure an electrical signal, for example, changes in capacitance, generated by the pressure sensors 210, and determine whether the sample is defective from the measurement. Further, the control unit 220 may adjust a location of the nozzle for ejecting the sample or a location of the receiving layer on which the sample is received according to whether the sample is defective, reset a threshold value that is a reference for determining whether the sample is defective, and display whether the sample is defective through a screen or a sound to the outside to inform a user of whether the sample is defective.

The memory 230 is a storage space for storing data and may store the threshold value which is compared to determine whether the sample is defective, locations of the nozzle and the receiving layer, test results accumulated for a predetermined period of time, and the like. The data stored in the memory 230 is withdrawn or renewed by a request of the control unit 220 and thus used to control the operation of the device 200 for testing droplets. As an example, if the control unit 220 determines that an excessive amount of sample is defective, the control unit 220 determines the threshold value compared to the amount or the location of the sample determined from the pressure sensors 210 to be inappropriate, and renew the threshold value stored in the memory 230 to another value. To this end, the memory 230 may store the data in a table form, which is renewable.

The communicating unit 240 is a module for communicating the device 200 for testing droplets and an external device, and, as an example, may connect a nozzle for ejecting a sample and the control unit 220 for communication. The control unit 220 may clean the nozzle or adjust the location of the nozzle through the communicating unit 240 according to a test result of the sample. The driving unit 250 for adjusting the location of the nozzle or the receiving layer according to whether the sample is defective may be included in the device 200 for testing droplets. The display unit 260 is a module for displaying the screen. The control unit 220 may display a test result of determining whether the sample is defective through the display unit 260. As described above, the device 200 for testing droplets may also include an audio output unit, as well as the display unit 260 or instead of the display unit 260, to inform the user of the test result through an audio output if the sample is determined to be defective.

The general operation of the device 200 for testing droplets according to the embodiment of the present invention will now be described with reference to FIG. 2.

The pressure sensors 210 are disposed below the receiving layer on which the sample is received, and generate predetermined electrical signals, for example, changes in capacitance, as the sample ejected from the nozzle is received on the receiving layer. When the device 200 for testing droplets includes the plurality of pressure sensors 210, the plurality of pressures sensors 210 are independently connected to respective sensing channels of the control unit 220 so that the control unit 220 may individually measure changes in capacitance generated by the plurality of respective pressures sensors 210 through the respective sensing channels.

When the control unit 220 measures the changes in capacitance generated by the plurality of respective pressures sensors 210, the control unit 220 determines whether the sample received on the receiving layer is defective based on the measured changes in electrostatic capacitance. As an example, when it is assumed that the plurality of pressure sensors 210 are disposed in a 3×3 matrix form, the control unit 220 may compare a total sum of changes in capacitance measured by nine pressure sensors 210 with a predetermined threshold value and determine whether an amount of the sample is appropriate. Since the changes in capacitance generated by the respective pressures sensors 210 are in proportional to a weight of the sample received on the receiving layer, if the total sum of the changes in capacitance measured by nine pressure sensors 210 is greater than the predetermined threshold value, the control unit 220 may determine that an excessive amount of the sample is ejected. Ina similar manner, if the total sum of the changes in capacitance measured by nine pressure sensors 210 is smaller than the predetermined threshold value, the control unit 220 may determine that a small amount of the sample is ejected.

Continuously, when it is assumed that nine pressure sensors 210 are disposed in a 3×3 matrix form, the control unit 220 may determine whether a location of the sample received on the receiving layer is defective from the changes in capacitance measured by the respective pressure sensors 210. Ideally, when the sample ejected in droplet form is received on the receiving layer, the highest capacitance changes are measured by the middle pressure sensor 210 of nine pressure sensors 210, and the same changes in capacitance are measured by eight surrounding pressure sensors 210. However, actually, since a case in which changes in capacitance measured in the sample ejected from the nozzle have such a threshold value is extremely rare, a threshold range within which the sample is determined to be normally ejected may be previously set in the form of two-dimensional coordinates on a plane parallel to the receiving layer, and, if the sample is ejected within the set threshold range, the sample may be determined to be normally ejected. To this end, the control unit 220 may measure changes in capacitance from each of nine pressure sensors 210, calculate a center point of the sample from the measured changes, and determine whether the center point of the sample is within the previously set threshold range.

When the control unit 220 determines that the sample ejected from the nozzle is defective through the above process, the control unit 220 may adjust the location of the nozzle or the receiving layer through the communicating unit 240 and the driving unit 250 or may clean the nozzle. If the control unit 220 determines that the amount of the sample is extremely large or small, the control unit 220 may transmit a nozzle cleaning command to a droplet ejection head through the communicating unit 240. Alternatively, if the control unit 220 determines that a sample ejection location is erroneous, the control unit 220 may move the location of the nozzle or the receiving layer through the driving unit 250.

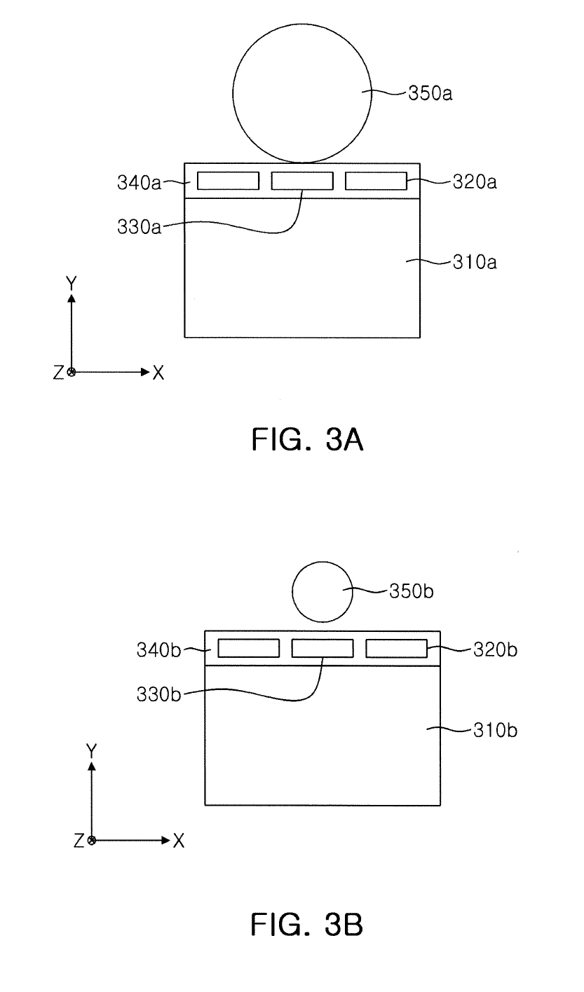

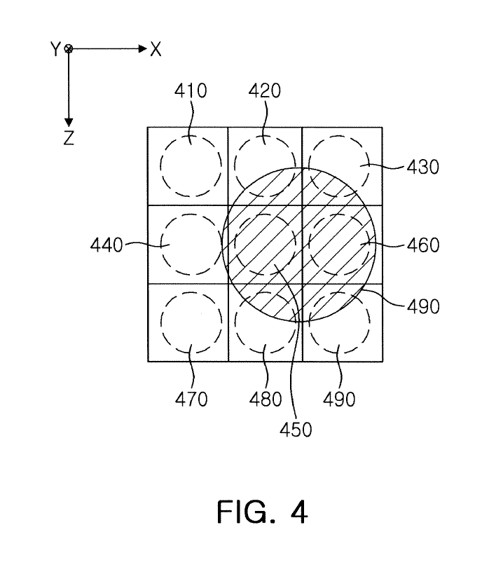

Meanwhile, the range of the threshold value that is a reference of determining whether the sample is defective needs to be differently determined according to a type of the sample ejected from the nozzle and ejecting environments, and the like. Therefore, if a sample defectivity rate (a rate of the sample determined to be defective) is extremely high based on test results accumulated for a predetermined period of time, the control unit 220 may determine that the threshold value for testing is erroneously set and, thus reset the threshold value for the testing. In this regard, the reset threshold value may be renewed, replacing the existing threshold value stored in the memory 230. FIGS. 3A, 3B, and 4 are diagrams for explaining an operation of a device for testing droplets according to an embodiment of the present invention.

FIGS. 3A and 3B are side views of a receiving layer and pressure sensors 320a˜340a and 320b˜340b. If samples 350a and 350b are received on the receiving layer, the pressure sensors 320a˜340a and 320b˜340b disposed below the receiving layer may generate changes in capacitance. A control unit (not shown) may measure the changes in capacitance, and determine whether the samples 350a and 350b are appropriately ejected.

Housing 310a and 310b having a substrate or the like electrically connecting the control unit and the pressure sensors 320a˜340a and 320b˜340b embedded therein, and physically supporting the receiving layer and the pressure sensors 320a˜340a and 320b˜340b, may be included under the receiving layer and the pressure sensors 320a˜340a and 320b˜340b.

In FIGS. 3A and 3B, the sample 350a exceeding a normal range and the sample 350b lacking the normal range are ejected and received on the receiving layer, respectively. If an extremely large amount of the sample 350a exceeding the normal range is received on the receiving layer as shown in FIG. 3A, the pressure sensors 320a˜340a generate significant changes in capacitance. The control unit determines if a sum of changes in capacitance measured by the respective pressure sensors 320a˜340a is within a predetermined threshold value range. In the case of FIG. 3A, the sum of changes in capacitance exceeds an upper limit of the predetermined threshold value range. Therefore, the control unit may determine that an amount of the sample 350a ejected from a nozzle is erroneous, and transfer a command to clear the nozzle or reduce the amount of the sample 350a ejected from the nozzle through a communicating unit.

Meanwhile, if an extremely small amount of the sample 350b lacking the normal range is received on the receiving layer as shown in FIG. 3B, the pressure sensors 320b˜340b generate very small changes in capacitance. Therefore, the control unit may determine that a sum of the changes in capacitance measured by the pressure sensors 320b˜340b is not reached to a lower limit of the predetermined threshold value range, and transfer a command to clear the nozzle or increase the amount of the sample 350b ejected from the nozzle to an ejection head.

FIG. 4 is a top view of a receiving layer and pressure sensors 410˜490 according to an embodiment of the present invention. Referring to FIG. 4, nine pressure sensors 410˜490 are disposed below the receiving layer in a 3×3 matrix form, and a sample 400 is received on the receiving layer. FIG. 4 is a view when the receiving layer and the pressure sensors shown in FIGS. 3A and 3B are viewed in a Y axis direction. The pressure sensors 410˜490 are disposed on a plane X-Z, and the sample 400 is received thereon.

In FIG. 4, when it is assumed that the sample 400 is not precisely dropped on the middle pressure sensor 450 of the pressure sensors 410˜490 disposed on the plane X-Z, i.e., a center point of the sample 400 is received in the right side in an X axis direction from the center of the receiving layer. In this regard, data numerically showing changes in capacitance measured by the respective pressure sensors 410˜490 may be listed in Table 1 below.

TABLE 1

| | | |
|---|---|---|
| 410 | 420 | 430 |
| 2 | 10 | 8 |
| 440 | 450 | 460 |
| 4 | 15 | 15 |
| 470 | 480 | 490 |
| 1 | 9 | 7 |

In Table 1 above, bold numbers indicate reference numerals of the pressure sensors 410˜490, and exemplary values of changes in capacitance measured by the respective pressure sensors 410˜490 corresponding to locations of the pressure sensors 410˜490 shown in FIG. 4 are indicated. That is, the pressure sensors 450 and 460 to which the highest pressure is applied by the greatest amount of samples generate the greatest changes in capacitance, and the pressure sensors 410 and 470 disposed in regions on which the sample 400 is not physically received generate little changes in capacitance. A control unit creates a database of the changes in capacitance measured by the pressure sensors 410˜490 as numerical values listed in Table 1 above, and calculates a location of the center point of the sample 400. The center point is expressed as a coordinate value (x, z) on the plane X-Z on which the pressure sensors 410˜490 are disposed, and is calculated using a weighted average obtained by summing data values of each row and column.

$$\begin{matrix}X = \frac{Σ [ ( sum of data of {n}^{th} row ) * n ]}{Σ [ sum of data of {n}^{th} row ]} \\ = \frac{7 * 1 + 34 * 2 + 30 * 3}{7 + 34 + 30} \\ = 2.32\end{matrix} \qquad [ Equation 1 ]$$

Similarly to Equation 1 above, a z axis coordinate is calculated as 1.95, an x axis coordinate is based on the left, and the z axis coordinate is based on the top. If the coordinate is calculated, the control unit determines whether a location of the sample 400 ejected from a nozzle is defective based on the calculated coordinate (2.32, 1.95). If the sample 400 is ideally ejected, the coordinates (x, z) are limited to (1.5, 1.5). However, actually, since the sample 400 may be not be dropped on a perfect center of the receiving layer, the control unit sets certain limit ranges ±Δx and ±Δz from the center coordinate (1.5, 1.5), and determines whether the sample 400 is defective.

For example, when both of ±Δx and ±Δz are set as 0.5, in the case of FIG. 4, the control unit may determine that the sample 400 is erroneously ejected and adjust a location of the nozzle or a sample receiving layer. Meanwhile, when ±Δx and ±Δz are set as 1.0 and 0.5, respectively, the control unit may determine that the sample 400 is normally ejected and allow the nozzle to eject a next sample without an adjustment.

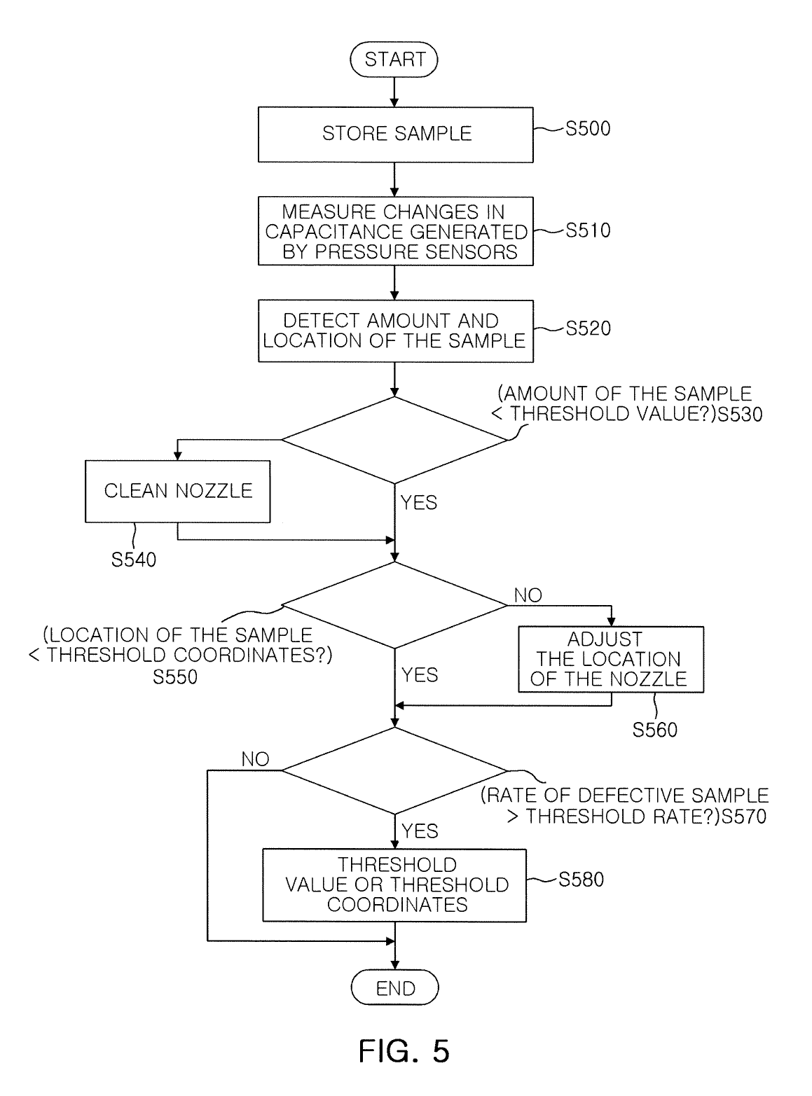

FIG. 5 is a flowchart of a method of operating a device for testing droplets according to an embodiment of the present invention.

Referring to FIG. 5, the method of operating a device for testing droplets according to the embodiment of the present invention starts with receiving a sample ejected from a nozzle in droplet form (S500). As the sample is received on a receiving layer, changes in capacitance in proportional to a weight of the sample may be generated in the pressure sensors 210 disposed below the receiving layer, and measured by the control unit 220 (S510). As described above, the control unit 220 may measure changes in capacitance from the plurality of respective pressure sensors 210 disposed below the receiving layer.

The control unit 220 calculates an amount and a location of the sample received on the receiving layer based on the measured changes in capacitance (S520). The location of the sample may be calculated using a method of calculating a center point location of the sample by using a weighted average as described with reference to FIG. 4. The amount of the sample may be calculated by summing data regarding changes in capacitance detected from all of the pressure sensors 210. If the amount and location of the sample are calculated, the control unit 220 compares the calculated amount of the sample with a predetermined threshold value (S530). The control unit 220 may determine whether the amount of the sample detected in S520 is within a previously set predetermined range.

As a result of the comparison in S530, if the control unit 220 determines that the detected amount of the sample exceeds the previously set predetermined range, the control unit 220 may transfer a nozzle cleaning command through the communicating unit 240 (S540). Alternatively, according to the comparison result, the control unit 220 may adjust the amount of the sample ejected from the nozzle to increase or be reduced.

As a result of the comparison in S530, if the detected amount of the sample is within the previously set predetermined range or the amount of the sample is completely adjusted in S540, the control unit 220 compares the location of the sample calculated in S520 with predetermined threshold coordinates (S550). The predetermined threshold coordinates may be set within a predetermined limit range from center coordinates of the receiving layer as described with reference to FIG. 4. If the control unit 220 determines that the location of the sample exceeds a threshold coordinate range, the control unit 220 may adjust a location of the nozzle (S560). Alternatively, the control unit 220 may adjust the location of the receiving layer other than the nozzle and allow the nozzle and the receiving layer to be arranged.

If the location of the sample is completely adjusted, the control unit 220 finally determines whether the sample of which test and adjustment has been complete through S520˜S560 is defective, stores corresponding information in the memory 230, and determines whether a sample defectivity rate (a rate of the tested sample determined to be defective) is greater than a predetermined threshold value, i.e. a threshold rate (S570). If the control unit 220 determines that the sample defectivity rate is greater than the threshold rate as a result of the determination in S570, since an extremely large amount of the sample is defective, it may be considered that the threshold value and the threshold coordinates that are references of determining whether the amount and the location of the sample are defective may be set to be within extremely narrow ranges or erroneously set in S530 and S550. Therefore, if the control unit 220 determines that the sample defectivity rate is greater than the threshold rate in S570, the control unit 220 may reset the threshold value and the threshold coordinate that are comparison references in S530 and S550, renew threshold value and the threshold coordinate to store the renewed threshold value and the threshold coordinate in the memory 230(S580).

As set forth above, according to embodiments of the invention, a location and amount of a sample are measured based on changes in capacitance generated by a plurality of pressure sensors disposed below a receiving layer on which the sample is received, a defect in the sample is determined from the changes, and a location and cleaning of a nozzle for ejecting the sample are adjusted, whereby precisely testing whether the sample ejected in droplet form is defective, and efficiently controlling a minute ejection head may be allowed.

While the present invention has been shown and described in connection with the embodiments, it will be apparent to those skilled in the art that modifications and variations can be made without departing from the spirit and scope of the invention as defined by the appended claims.

What is claimed is:

1. A device for testing droplets, the device comprising:
a receiving layer on which a sample is received;
a plurality of pressure sensors disposed below the receiving layer, and generating changes in capacitance by the sample received on the receiving layer; and
a control unit measuring changes in capacitance generated by the plurality of pressure sensors and determining whether the sample received on the receiving layer is defective.

2. The device of claim 1, wherein the plurality of pressure sensors are disposed below the receiving layer to have a predetermined pattern.

3. The device of claim 1, wherein the control unit determines at least one of an amount and a location of the sample received on the receiving layer based on the changes in capacitance.

4. The device of claim 3, wherein the control unit adjusts a nozzle for ejecting the sample when the control unit determines that at least one of the amount and the location of the sample received on the receiving layer is beyond a previously set threshold range.

5. The device of claim 4, wherein the control unit controls the nozzle for ejecting the sample such that the nozzle is cleaned, when the control unit determines that the amount of the sample received on the receiving layer is beyond the previously set threshold range.

6. The device of claim 4, wherein the control unit adjusts a location of the nozzle for ejecting the sample when the control unit determines that the location of the sample received on the receiving layer is beyond the previously set threshold range.

7. The device of claim 4, wherein the control unit resets the previously set threshold range when a rate of the sample determined to be defective is greater than a specific numerical value, the sample being received on the receiving layer.

8. A method of operating a device for testing droplets, the method comprising:
receiving a sample ejected from a nozzle;
measuring changes in capacitance generated by a plurality of pressure sensors by the sample;
determining whether the sample is defective based on the changes in capacitance; and
controlling the nozzle according to whether the sample is defective.

9. The method of claim 8, wherein the measuring of changes in capacitance includes: measuring changes in capacitance generated by the plurality of pressure sensors disposed to have a predetermined pattern.

10. The method of claim 8, wherein the determining of whether the sample is defective, includes: determining that the sample is defective when at least one of an amount and a location of the sample detected from the changes in capacitance is beyond a previously set threshold range.

11. The method of claim 10, wherein the controlling of the nozzle includes: cleaning the nozzle when the amount of the sample is beyond the previously set threshold range.

12. The method of claim 10, wherein the controlling of the nozzle includes: adjusting a location of the nozzle when the location of the sample is beyond the previously set threshold range.

13. The method of claim 10, further comprising: resetting the previously set threshold range when a rate of the sample determined to be defective is greater than a specific numerical value, the sample being received on the receiving layer.
